(19) United States
(12) Patent Application Publication
(10) Pub. No.: US 2019/0067698 A1
(43) Pub. Date: Feb. 28, 2019

(54) BINDER RESIN FOR SECONDARY BATTERY ELECTRODES, BINDER RESIN COMPOSITION FOR SECONDARY BATTERY ELECTRODES USING SAME, SLURRY FOR SECONDARY BATTERY ELECTRODES, ELECTRODE FOR SECONDARY BATTERIES, AND SECONDARY BATTERY

(71) Applicant: MITSUBISHI CHEMICAL CORPORATION, Tokyo (JP)

(72) Inventors: Akikazu MATSUMOTO, Tokyo (JP); Fumiko FUJIE, Tokyo (JP); Haruki OKADA, Tokyo (JP)

(73) Assignee: MITSUBISHI CHEMICAL CORPORATION, Tokyo (JP)

(21) Appl. No.: 15/768,659

(22) PCT Filed: Oct. 16, 2015
(86) PCT No.: PCT/JP2015/079339

§ 371 Date: Apr. 16, 2018

(51) Int. Cl. H01M 4/62

(52) U.S. Cl. CPC H01M 4/622

(57) ABSTRACT

The use of a binder resin for a secondary battery electrode which is a polymer characterized by containing, as polymer-constituent monomer units, a vinyl cyanide monomer unit at a ratio of 50 to 99.99% by mole and a phosphoric acid group-containing monomer unit at a ratio of 0.01 to 50% by mole, and preferably having a mass-average molecular weight of 200,000 to 3,000,000 makes it possible to obtain a battery in which the in-battery electrochemical stability of the vinyl cyanide monomer unit is exhibited, while the phosphoric acid group-containing monomer unit exhibits an excellent binding property to a current collector to improve the flexibility of the current collector.

### TECHNICAL FIELD

The present invention relates to a binder resin for a secondary battery electrode, a slurry composition for a secondary battery electrode comprising the binder resin, an active material, and a solvent, an electrode for a secondary battery comprising the binder resin, and a secondary battery comprising the electrode.

### BACKGROUND ART

Recently, lithium ion secondary batteries have been used for portable devices such as mobile phones, video cameras, and laptop computers and for hybrid vehicles and electric vehicles. In general, an electrode for a lithium ion secondary battery is obtained by mixing a solvent with a mixture obtained by adding a suitable amount of a binder to a raw material for an electrode active material to form a paste, applying the paste onto a current collector, followed by drying and then compression bonding. As the binder, polyvinvlidene fluoride (hereinafter referred to as “PVDF”) has been used, which is a material having satisfactory solvent resistance to an organic solvent used for an electrolyte solution, and satisfactory oxidation resistance and reduction resistance within the drive voltage, and the like. However, PVDF has a problem of poor binding property to a current collector.

As a method for improving the poor binding property due to PVDF, the use of a (meth)acrylonitrile polymer has been proposed. For example, in Patent Literatures 1 and 2, an acrylonitrile polymer is used as a binder to improve the binding property or adhesion to the current collector.

In addition, Patent Literature 3 proposes the use of a copolymer containing an acrylic acid ester and a phosphate ester as a binder resin and states that the phosphate ester exhibits the binding property to a current collector, and also the dispersibility of the active material is improved, which make it possible to obtain an electrode excellent in the battery performance.

### CITATION LIST

### Patent Literatures

Patent Literature 1: International Publication No. WO2002/039518

### Patent Literature 2: Japanese Patent Application Publication No. 2010-174058

Patent Literature 3: International Publication No. WO2006/101182

### SUMMARY OF INVENTION

### Technical Problems

However, in the case of Patent Literature 1, the amount of acrylonitrile relative to the entire amount of the binder is so small that the good binding property of the (meth)acrylonitrile polymer to a current collector is not sufficiently exhibited.

Meanwhile, Patent Literature 2 proposes a binder for an electrode comprising an acrylonitrile polymer as a main component. However, when a (meth)acrylonitrile polymer is the main component, it is conceivable that the fabricated electrode is so poor in flexibility that the mixture layer may be fractured or cracked in a winding step during the production process, making it difficult to produce a battery.

In addition, the binding property to a current collector is improved, when an acrylic acid ester unit is polymerized in a binder resin as described in Patent Literature 3. However, since the acrylic acid ester unit is the main component, there is a concern that decomposition may occur because of the redox reaction in the battery, so that the expected battery performance cannot be exhibited, especially in the use for a long period.

### Solution to Problems

In view of the above-described problems and discussion, the present inventors have conducted intensive study, and consequently have found that the use of a binder resin for a secondary battery electrode which is a polymer characterized by containing, as polymer-constituent monomer units, a vinyl cyanide monomer unit at a ratio of 50 to 99.99% by mole and a phosphoric acid group-containing monomer unit at a ratio of 0.01 to 50% by mole, and having a mass-average molecular weight of 200,000 to 3,000,000 makes it possible to obtain a battery in which the in-battery electrochemical stability of the vinyl cyanide monomer unit is exhibited, while the phosphoric acid group-containing monomer unit exhibits an excellent binding property to a current collector to improve the flexibility of an electrode.

The present invention relates to the following:

[1] A binder resin for a secondary battery electrode, comprising

a polymer (A) which contains, as polymer-constituent monomer units, a vinyl cyanide monomer unit at a ratio of 50 to 99.99% by mole and a phosphoric acid group-containing monomer unit at a ratio of 0.01 to 50% by mole, and which has a mass-average molecular weight of 200,000 to 3,000,000.

[2] The binder resin for a secondary battery electrode according to the above-described [1], further comprising

a polymer (B) which contains, as polymer-constituent monomer units, a vinyl cyanide monomer unit at a ratio of 50 to 99.99% by mole and a carboxyl group-containing monomer unit at a ratio of 0.01 to 50% by mole.

[3] The binder resin for a secondary battery electrode according to the above-described [1] or [2], wherein

the mass-average molecular weight of the polymer (A) is 200,000 to 2,000,000.

[4] The binder resin for a secondary battery electrode according to the above-described [2] or [3], wherein

the mass-average molecular weight of the polymer (B) is 200.000 to 2,000,000. [5] The binder resin for a secondary battery electrode according to any one of the above-described [2] to [4], wherein

the polymer (A) is contained at a ratio of 0.1 to 99% by mass, and the polymer (B) is contained at a ratio of 1 to 99.9% by mass, provided that the total of (A) and (B) is 100% by mass.

[6] The binder resin for a secondary battery electrode according to the above-described [1], further comprising

a polymer (C) which contains a vinyl cyanide monomer unit as a polymer-constituent monomer unit, and which does not contain an acidic group-containing monomer unit.

[7] The binder resin for a secondary battery electrode according to any one of the above-described [2] to [5], further

a polymer (C) which contains a vinyl cyanide monomer unit as a polymer-constituent monomer unit, and which does not contain an acidic group-containing monomer unit.

[8] The binder resin for a secondary battery electrode according to the above-described [6] or [7], wherein

the polymer (C) has a mass-average molecular weight of 1,000 to 2,000,000.

[9] The binder resin for a secondary battery electrode according to the above-described [6] or [8], wherein

the polymer (A) is contained at a ratio of 10 to 99% by mass, and the polymer (C) is contained at a ratio of 1 to 90% by mass, provided that the total of (A) and (C) is 100% by mass.

[10] The binder resin for a secondary battery electrode according to the above-described [7] or [8], wherein

the polymer (A) is contained at a ratio of 0.1 to 99% by mass, the polymer (B) is contained at a ratio of 0.9 to 99.8% by mass, and the polymer (C) is contained at a ratio of 0.1 to 94.1% by mass, provided that the total of (A). (B), and (C) is 100% by mass.

[11] A binder resin composition for a secondary battery electrode, comprising:

the binder resin for a secondary battery electrode according to any one of the above-described [1] to [10]; and

a polycondensate of a polyol.

[12] An electrode slurry, comprising:

the binder resin for a secondary battery electrode according to any one of the above-described [1] to [10];

an active material; and

a solvent.

[13] An electrode slurry, comprising:

the binder resin composition for a secondary battery electrode according to the above-described [1];

an active material; and

a solvent.

[14] An electrode for a secondary battery, comprising:

a current collector; and

a mixture layer provided on the current collector, wherein

the mixture layer comprises the binder resin for a secondary battery electrode according to any one of the above-described [1] to [10].

[15] An electrode for a secondary battery, comprising:

a current collector; and

a mixture layer provided on the current collector, wherein

the mixture layer comprises the binder resin composition for a secondary battery electrode according to the above-described [11].

[16]

A non-aqueous secondary battery, comprising

the electrode for a secondary battery according to the above-described [14] or [15].

### Advantageous Effects of Invention

The present invention makes it possible to provide a binder resin for a secondary battery electrode, a binder resin composition for a secondary battery electrode, and an electrode slurry composition for a secondary battery which are excellent in binding property to a current collector, leading to a good flexibility of an electrode. From the binder resin, it is also possible to provide an electrode for a secondary battery and a non-aqueous secondary battery which are excellent in flexibility. Moreover, the binder resin for a secondary battery electrode of the present invention makes it possible to obtain an electrode for a secondary battery and a non-aqueous secondary battery which are high in electrochemical stability.

### DESCRIPTION OF EMBODIMENTS

Hereinafter, the present invention will be described in detail.

An aspect of the binder resin of the present invention is a binder resin for a secondary battery electrode, comprising a polymer (A) which contains, as polymer-constituent monomer units, a vinyl cyanide monomer unit at a ratio of 50 to 99.99% by mole and a phosphoric acid group-containing monomer unit at a ratio of 0.01 to 50% by mole, and which has a mass-average molecular weight of 200.000 to 3,000,000.

Meanwhile, another aspect of the binder resin of the present invention is a binder resin for a secondary battery electrode, comprising:

a polymer (A) which contains, as polymer-constituent monomer units, a vinyl cyanide monomer unit at a ratio of 50 to 99.99% by mole and a phosphoric acid group-containing monomer unit at a ratio of 0.01 to 50% by mole, and which has a mass-average molecular weight of 200,000 to 3,000,000; and

a polymer (B) which contains, as polymer-constituent monomer units, a vinyl cyanide monomer unit at a ratio of 50 to 99.99% by mole and a carboxyl group-containing monomer unit at a ratio of 0.01 to 50% by mole.

Hereinafter, the binder resin for a secondary battery electrode of the present invention is described.

### <Polymer (A)>

The polymer (A) used in the binder resin for a secondary battery electrode of the present invention contains, as polymer-constituent monomer units, a vinyl cyanide monomer unit at a ratio of 50 to 99.99% by mole and a phosphoric acid group-containing monomer unit at a ratio of 0.01 to 50% by mole, and has a mass-average molecular weight of 200,000 to 3,000,000.

### <Vinyl Cyanide Monomer Unit>

Examples of vinyl cyanide monomers from which the vinyl cyanide monomer unit is derived include (meth)acrylonitriles such as acrylonitrile and methacrylonitrile; cyanic nitrile group-containing monomers such as α-cyanoacrylate and dicyanovinylidene; and fumaric nitrile group-containing monomers such as fumaronitrile. Of these monomers, (meth)acrylonitrile is preferable in terms of ease of polymerization and cost-performance.

One of these vinyl cyanide monomers may be used alone, or two or more thereof may be used in combination.

The content ratio of the vinyl cyanide monomer unit is 50 to 99.99% by mole, preferably 80 to 99.95% by mole, more preferably 90 to 99.9% by mole, further preferably 96 to 99.9% by mole, and most preferably 98 to 99.7% by mole relative to all the monomer units constituting the polymer (A). Here, all the monomer units constituting the polymer (A) is taken as 100% by mole.

When the content ratio of the vinyl cyanide monomer unit is 50% by mole or higher, not only the polymer (A) can be easily dissolved in a solvent during the preparation of a slurry, but also the prepared polymer (A) can be present electrochemically stably in a battery for a long period.

### <Phosphoric Acid Group-Containing Monomer Unit>

Monomers from which the phosphoric acid group-containing monomer unit is derived are phosphoric acid group-containing vinyl monomers, and preferably phosphoric acid group-containing (meth)acrylates and phosphoric acid group-containing allyl compounds.

Examples of the phosphoric acid group-containing (meth)acrylates include 2-(meth)acryloyloxyethyl acid phosphate, 2-(meth)acryloyloxyethyl acid phosphate monoethanolamine salt, diphenyl ((meth)acryloyloxyethyl) phosphate, (meth)acryloyloxypropyl acid phosphate, 3-chloro-2-acid phosphooxypropyl (meth)acrylate, acid phosphooxypolyoxyethylene glycol mono(meth)acrylate, and acid phosphooxypolyoxypropylene glycol (meth)acrylate.

An example of the phosphoric acid group-containing allyl compounds is allyl alcohol acid phosphate.

Of these phosphoric acid group-containing vinyl monomers, 2-methacryloyloxyethyl acid phosphate is preferable, because the binding property to a current collector and the handleability during electrode production are excellent.

2-Methacryloyloxyethyl acid phosphate is industrially available as LIGHT ESTER P1-M (trade name, manufactured by Kyoeisha Chemical Co., Ltd.).

One of these phosphoric acid group-containing vinyl monomers may be used alone, or two or more thereof may be used in combination.

The content ratio of the phosphoric acid group-containing monomer unit is 0.01 to 50% by mole, preferably 0.05 to 20% by mole, more preferably 0.1 to 10% by mole, further preferably 0.1 to 4% by mole, and most preferably 0.3 to 2% by mole relative to all the monomer units constituting the polymer (A). Here, all the monomer units constituting the polymer (A) is taken as 100% by mole.

When the content ratio of the phosphoric acid group-containing monomer unit is 0.01% by mole or higher, the binding property to a current collector is enhanced. When the content ratio of the phosphoric acid group-containing monomer unit is not higher than the upper limit value, the polymer (A) easily dissolves into a solvent during the preparation of a slurry, so that the binding property to a current collector is enhanced.

The polymer (A) of the present invention can contain other monomer units, in addition to the vinyl cyanide monomer unit and the phosphoric acid group-containing monomer unit.

Examples of other monomers from which the other monomer units are derived include short-chain (meth)acrylic acid ester monomers such as methyl (meth)acrylate, ethyl (meth)acrylate, butyl (meth)acrylate, and hexyl (meth)acrylate; long-chain (meth)acrylic acid ester monomers such as stearyl (meth)acrylate and lauryl (meth)acrylate; vinyl halide monomers such as vinyl chloride, vinyl bromide, and vinylidene chloride; maleimides such as maleic acid imide and phenylmaleimide aromatic vinyl monomers such as styrene and α-methylstyrene; (meth)acrylamide, and vinyl acetate.

The content ratio of the other monomer units is an amount which gives 100% by mole, when added to the content ratios (% by mole) of the vinyl cyanide monomer unit and the phosphoric acid group-containing monomer unit.

### <Mass-Average Molecular Weight of Polymer (A)>

The mass-average molecular weight of the polymer (A) of the present invention is 200,000 to 3,000,000, preferably 200,000 to 2,000,000, more preferably 230,000 to 1,000,000, further preferably 250,000 to 750,000, and most preferably 350,000 to 500,000. When the mass-average molecular weight of the polymer (A) is not lower than the lower limit value, the polymer is prevented from excessively easily dissolving into a solvent during the preparation of a slurry, so that the polymer (A) can bind an active material in the slurry without covering the active material, and the flexibility of the electrode after the application can be improved. Meanwhile, when the mass-average molecular weight is not higher than the upper limit value, the polymer (A) can dissolve into a solvent during the preparation of a slurry, so that an excellent binding property to a current collector can be exhibited.

In the present description, the mass-average molecular weight can be determined by a known suitable method, and the mass-average molecular weight was measured by GPC (Gel Permeation Chromatography) in Examples of the present description.

### <Method for Producing Polymer (A)>

As a polymerization method of the polymer (A), solution polymerization, suspension polymerization, emulsion polymerization, or the like can be selected according to the types of the monomers used, the solubility of the polymer produced, and the like.

As a method for adding the monomers in the above-described solution polymerization, suspension polymerization, or emulsion polymerization, it is possible to select a polymerization method in which the entire amounts of the monomers are charged at once, or a polymerization method in which all the monomers are added dropwise little by little.

### <Polymerization Initiator>

As a polymerization initiator used when suspension polymerization or emulsion polymerization is carried out, a water-soluble polymerization initiator is preferable, because of its excellence in polymerization initiation efficiency and the like.

Examples of the water-soluble polymerization initiator include persulfuric acid salts such as potassium persulfate, ammonium persulfate, and sodium persulfate; water-soluble peroxides such as hydrogen peroxide; and water-soluble azo compounds such as 2,2′-azobis(2-methylpropionamidine) dihydrochloride.

Oxidizing agents such as persulfuric acid salts can also be used as redox-system initiators in combination with a reducing agent such as sodium hydrogen sulfite, ammonium hydrogen sulfite, sodium thiosulfate, or hydrosulfite and a polymerization promoter such as sulfuric acid, iron sulfate, or copper sulfate.

Of these polymerization initiators, persulfuric acid salts are preferable, because a copolymer is easily produced.

### <Chain Transfer Agent>

When suspension polymerization or emulsion polymerization is carried out, a chain transfer agent can be used for the purposes of molecular weight adjustment and the like.

When the chain transfer agent is used, the amount of the chain transfer agent added is preferably 0.001 to 10% by mass relative to the monomers.

Examples of the chain transfer agent include mercaptan compounds, thioglycol, carbon tetrachloride. α-methylstyrene dimer, and sodium hypophosphite. Of these chain transfer agents, α-methylstyrene dimer or sodium hypophosphite is preferable because of the weak odor and ease of handling.

### <Solvent>

When suspension polymerization is carried out, a solvent other than water can be added to adjust the particle diameter of the obtained copolymer.

Examples of the solvent other than water include amides such as N-methylpyrrolidone (NMP), N,N-dimethylacetamide, and N,N-dimethylformamide; ureas such as N,N-dimethylethyleneurea, N,N-dimethylpropyleneurea, and tetramethylurea lactones such as γ-butyrolactone and γ-caprolactone; carbonates such as propylene carbonate; ketones such as acetone, methyl ethyl ketone, methyl isobutyl ketone, and cyclohexanone; esters such as methyl acetate, ethyl acetate, n-butyl acetate, butyl cellosolve acetate, butyl carbitol acetate, ethyl cellosolve acetate, and ethyl carbitol acetate; glymes such as diglyme, triglyme, and tetraglyme; hydrocarbons such as toluene, xylene, and cyclohexane; sulfoxides such as dimethyl sulfoxide; sulfones such as sulfolane; and alcohols such as methanol, isopropanol, and n-butanol.

One of these solvents may be used alone, or two or more thereof may be used in combination.

When the solvent other than water is used, the solvent is preferably added in the range of 0.01 to 100 parts by mass relative to 100 parts by mass of water.

### <Surfactant>

When the polymer (A) is produced by emulsion polymerization, a surfactant can be used.

Examples of the surfactant include anionic surfactants such as dodecyl sulfate salts and dodecylbenzenesulfonic acid salts; nonionic surfactants such as polyoxyethylene alkyl ethers and polyoxyethylene alkyl esters; and cationic surfactants such as alkyltrimethylammonium salts and alkylamines. One of these surfactants may be used alone, or two or more thereof may be used in combination.

### <Polymer (B)>

As an aspect of the binder resin for a secondary battery electrode of the present invention, an aspect further comprising a polymer (B) in addition to the polymer (A) is preferable.

The polymer (B) contains, as polymer-constituent monomer units, a vinyl cyanide monomer unit at a ratio of 50 to 99.99% by mole and a carboxyl group-containing monomer unit at a ratio of 0.01 to 50% by mole. Here, all the monomer units constituting the polymer (B) is taken as 100% by mole.

Monomers from which the carboxyl group-containing monomer unit is derived include carboxyl group-containing vinyl monomers such as (meth)acrylic acid, itaconic acid, and crotonic acid, as well as salts thereof. Methacrylic acid is preferable, because it is excellent in binding property to a current collector and in handleability during electrode production. One of these carboxyl group-containing vinyl monomers may be used alone, or two or more thereof may be used in combination.

As the carboxyl group-containing polymer (B) contained in the binder resin, one carboxyl group-containing polymer may be used alone, or two or more carboxyl group-containing polymers may be used in combination.

### <Mass-Average Molecular Weight of Polymer (B)>

The mass-average molecular weight of the polymer (B) of the present invention is preferably 200,000 to 2,000,000, more preferably 230,000 to 1,000,000, further preferably 250,000 to 750,000, and most preferably 350,000 to 500,000. When the mass-average molecular weight of the polymer (B) is not lower than the lower limit value, the polymer is prevented from excessively easily dissolving into a solvent during the preparation of a slurry, so that the polymer (B) can bind an active material in the slurry without covering the active material, and the flexibility of the electrode after the application can be improved. Meanwhile, when the mass-average molecular weight is the above-described upper limit value or lower, the polymer (B) easily dissolves into a solvent during the preparation of a slurry, so that an excellent binding property to a current collector can be exhibited.

### <Method for Producing Polymer (B)>

The polymer (B) can be produced by a known polymerization method. For example, the polymer (B) can be polymerized preferably by using the same polymerization method, polymerization initiator, chain transfer agent, solvent, and surfactant as those for the polymer (A), except that the carboxyl group-containing vinyl monomer is used instead of the phosphoric acid group-containing vinyl monomer.

When the binder resin contains the carboxyl group-containing polymer (B), the ratio of the polymer (A) is preferably 0.1 to 99% by mass, more preferably 1 to 95% by mass, and further preferably 1.5 to 90% by mass, where the total of all the polymers (for example, A+B) contained in the binder resin is taken as 100% by mass.

The ratio of the polymer (B) is preferably 1 to 99.9% by mass, more preferably 5 to 99% by mass, and further preferably 10 to 98.5% by mass. When the content ratio of the polymer (B) is not higher than the upper limit value of the above-describe range, a mixture layer formed by applying a slurry containing the resin composition has a better flexibility. When the content ratio of the polymer (B) is not lower than the lower limit value of the above-describe range, a slurry using the binder resin of the present invention is excellent in application stability.

### <Polymer (C)>

The binder resin for a secondary battery electrode of the present invention may further comprise a polymer (C) which contains a vinyl cyanide monomer unit and which does not contain an acidic group-containing monomer unit.

The vinyl cyanide monomer unit contained in the polymer (C) is the same as the vinyl cyanide monomer unit as that described for the polymer (A).

One vinyl cyanide monomer unit may be contained alone in the polymer (C), or two or more vinyl cyanide monomer units may be contained therein.

The polymer (C) preferably contains the vinyl cyanide monomer unit as the main component. When the vinyl cyanide monomer unit is the main component, the solubility or dispersibility of the resin composition in a non-aqueous solvent is improved, so that the binding property of a mixture layer using the resin composition as a binder to a current collector is improved.

The “main component” indicates that the content ratio of the vinyl cyanide monomer unit is higher than 50% by mole and 100% by mole or lower, where all the monomer units constituting the polymer (C) are taken as 1000/% by mole.

The content ratio of the vinyl cyanide monomer unit in the polymer (C) is preferably 90 to 100% by mole relative to all the monomer units constituting the polymer (C).

The mass-average molecular weight of the polymer (C) is preferably 1,000 to 2,000,000, more preferably 30,000 to 1,000,000, further preferably 30,000 to 500,000, and most preferably 50,000 to 500,000.

The mass-average molecular weight of the polymer (C) can be determined by the same method as that for the mass-average molecular weight of the polymer (A).

As the polymer (C), a commercially available one may be used, or one produced by a known production method may be used.

The polymer (C) can be produced by a known polymerization method. For example, the polymer (C) can be produced by the same production method as that described for the polymer (A), except that no acidic group-containing vinyl monomer is used.

As the polymer (C) contained in the binder resin, one of such polymers may be used alone, or two or more thereof may be used in combination.

When the binder resin contains the polymer (C), the ratio of the polymer (C) is preferably 1 to 90% by mass, more preferably 5 to 70% by mass, further preferably 10 to 50% by mass, and most preferably 10 to 35% by mass, where the total of the polymer (A) and the polymer (C) contained in the binder resin is taken as 100% by mass.

In addition, when the total of the polymer (A), the polymer (B), and the polymer (C) contained in the binder resin is taken as 100% by mass, the ratio of the polymer (C) is preferably 0.1 to 94.1% by mass (where the polymer (A) is 0.1 to 99% by mass, and the polymer (B) is 0.9 to 99.8% by mass), more preferably 3 to 70% by mass (where the polymer (A) is 1 to 95% by mass, and the polymer (B) is 23 to 96% by mass), and further preferably 5 to 50%0/by mass (where the polymer (A) is 1.5 to 90% by mass, and the polymer (B) is 40 to 93.5% by mass).

When the content ratio of the polymer (C) is not higher than the upper limit value of the above-describe range, a mixture layer formed by applying a slurry containing the resin composition has a better flexibility. When the content ratio of the polymer (C) is not lower than the lower limit value of the above-describe range, a slurry using the binder resin of the present invention is excellent in application stability.

### <Binder Resin>

The binder resin of the present invention is a resin containing at least the polymer (A), and may further contain the polymer (B) and/or the polymer (C).

### <Binder Resin Composition>

The binder resin for a secondary battery electrode of the present invention may be combined with additives such as an additional “binder” that improves a battery performance, a “viscosity modifier” that improves the applicability, and a “plasticizer” that improves the flexibility of an electrode, within a range not impairing a desired effect of the present invention.

Examples of the additional binder include polymers such as styrene-butadiene rubber, poly(meth)acrylonitrile, and ethylene-vinyl alcohol copolymer; and fluorine-containing polymers such as PVDF, tetrafluoroethylene, and pentafluoropropylene.

Examples of the viscosity modifier include cellulose-based polymers such as carboxymethyl cellulose, methyl cellulose, and hydroxypropyl cellulose, and ammonium salts thereof; poly((meth)acrylic acid salts) such as poly(sodium (meth)acrylate); polyvinyl alcohol, polyethylene oxide, polyvinylpyrrolidone, copolymers of acrylic acid or an acrylic acid salt with vinyl alcohol, copolymers of maleic anhydride, maleic acid, or fumaric acid with vinyl alcohol, modified polyvinyl alcohols, modified polyacrylic acids, polyethylene glycol, and polycarboxylic acid.

Examples of the plasticizer include hydroxy group-containing compounds. Specific examples thereof include glycols, glycerins, and erythritols. Polyethylene glycol and polyglycerin, which are polycondensates of polyols, are preferable, because of their resistance to elution into the electrolyte solution.

Additives that remain in the electrode to the end preferably have electrochemical stability.

It may be more preferable that the binder resin composition of the present invention contain the above-described polycondensate of a polyol. In such a case, the ratio of the polycondensate of a polyol is preferably 0.1 to 25% by mass, more preferably 1 to 20% by mass, further preferably 3 to 15% by mass, and most preferably 5 to 10% by mass relative to 100% by mass of the binder resin composition. When the ratio of the polycondensate of a polyol is the above-described upper limit value or lower, the performance of the binder resin is less likely to be impaired. When the ratio of the polycondensate of a polyol is the above-described lower limit value or higher, the flexibility of an electrode can be increased.

The binder resin for a secondary battery electrode may be used in the form of any one of a powder, a solution in which the binder resin is dissolved in a solvent, and an emulsion in which the binder resin is dispersed in an aqueous or oil-based medium.

### <Uses of Binder Resin>

The types of batteries for which the binder resin for a secondary battery of the present invention can be used are not particularly limited, and it is particularly preferable to use the binder resin for positive electrodes or negative electrodes in non-aqueous secondary batteries, especially, lithium ion secondary batteries.

### <Slurry Composition for Secondary Battery Electrode>

A slurry composition for a secondary battery electrode comprises at least the above-described binder resin or binder resin composition, an electrode active material, and a solvent. Moreover, the slurry composition may further comprise a conductive auxiliary agent and other additives. Specifically, the slurry composition can be obtained by dispersing or dissolving the binder resin for a secondary battery electrode of the present invention and an electrode active material in a solvent, together with a conductive auxiliary agent and other additives.

The constitution of the slurry composition for a secondary battery electrode is preferably such that the binder resin for a secondary battery electrode of the present invention is 0.1 to 10 parts by mass, and the conductive auxiliary agent is 0.5 to 20 parts by mass, where the active material is taken as 100 parts by mass. In addition, the other additives may be added at a ratio of 0 to 10 parts by mass.

### <Electrode for Secondary Battery>

An electrode for a secondary battery comprises: a current collector; and a mixture layer provided on at least one surface of the current collector. The binder resin of the present invention is used as a material to constitute the mixture layer. Specifically, the mixture layer is a solid phase obtained by drying a slurry composition which has been obtained by dissolving or dispersing the binder resin for a secondary battery electrode of the present invention in a solvent with an active material blended therein.

The active material used in the mixture layer may be any, as long as the electric potential of a positive electrode material and the electric potential of a negative electrode material are different from each other.

Examples of positive electrode active materials used in the case of a lithium ion secondary battery include lithium-containing metal composite oxides comprising: at least one or more metals selected from iron, cobalt, nickel, manganese; and lithium. One of these positive electrode active materials may be used alone, or two or more thereof may be used in combination.

Meanwhile, examples of negative electrode active materials used include lithium titanate, carbon materials such as graphite, amorphous carbon, carbon fiber, coke, and activated carbon; and composites of the above-described carbon materials with a metal such as silicon, tin, or silver or with an oxide thereof. One of these negative electrode active materials may be used alone, or two or more thereof may be used in combination.

In a lithium ion secondary battery, it is preferable to use a lithium-containing metal composite oxide for the positive electrode and graphite for the negative electrode. This combination results in a lithium ion secondary battery with a voltage of approximately 4 V.

Note that a conductive auxiliary agent may be used in combination with the positive electrode active material or the negative electrode active material.

Examples of the conductive auxiliary agent include graphite, carbon black, carbon nanotube, carbon nanofiber, acetylene black, Ketjenblack, and electrically conductive polymers. One of these conductive auxiliary agents may be used alone, or two or more thereof may be used in combination.

The current collector only needs to be a substance having electrical conductivity, and a metal can be used as the material. Metals that are less likely to form alloys with lithium are desirable, and specifically such metals include aluminum, copper, nickel, iron, titanium, vanadium, chromium, manganese, and alloys thereof.

The shape of the current collector may be a thin film-like shape, a net-like shape, or a fibrous shape. Of these shapes, the thin film-like shape is preferable. The thickness of the current collector is preferably 5 to 30 μm, and more preferably 8 to 25 μm.

The mixture layer is formed by using a binder resin comprising an electrode active material and the like. The mixture layer is obtained, for example, by preparing a slurry composition comprising the above-described binder resin, additives, solvent, and electrode active material, applying this slurry composition onto a current collector, and removing the solvent by drying.

Example of the solvent used for the preparation of the slurry composition may be water, NMP, N-ethylpyrrolidone, N,N-dimethylformamide, tetrahydrofuran, dimethylacetamide, dimethyl sulfoxide, hexamethylsulfolamide, tetramethylurea, acetone, methyl ethyl ketone, a mixture solvent of NMP with an ester solvent (ethyl acetate, n-butyl acetate, butyl cellosolve acetate, butyl carbitol acetate, or the like), a mixture solvent of a mixture solution of NMP with a glyme solvent (diglyme, triglyme, tetraglyme, or the like), and NMP is especially preferable. One of these solvents may be used alone, or two or more thereof may be used in combination.

Moreover, if necessary, additives such as a dispersing agent and a viscosity modifier can be added to the slurry composition. Specifically, the additives may be a rheology controlling agent that adjusts the viscosity of the slurry, a leveling agent that provides the smoothness after application to a current collector, and a dispersing agent. A known additive can be used as any of these additives.

In an example of a process for fabricating an electrode, a slurry is obtained by kneading the binder resin for a secondary battery electrode of the present invention, an electrode active material, and acetylene black in the presence of a solvent, for example, NMP. The slurry is applied onto an electrode current collector and dried, and then, if necessary, pressed to obtain an electrode. The drying conditions are not particularly limited, as long as the solvent can be sufficiently removed and the binder for a battery is not decomposed under the conditions. It is preferable to perform a heat treatment at 40 to 160° C., preferably at 60 to 140° C. for 1 minute to 10 hours. Within these ranges, the binder resin for a secondary battery can provide the binding between an active material and a current collector, or between active materials without decomposition.

A negative electrode structure and a positive electrode structure fabricated as described above are arranged with a liquid-permeable separator (for example, a porous film made of polyethylene or polypropylene) interposed therebetween, followed by impregnation with a non-aqueous electrolyte solution to form a non-aqueous secondary battery. Meanwhile, a tubular secondary battery is obtained by winding a laminate made up of a negative electrode structure in which active layers are formed on both sides/a separator/a positive electrode structure in which active layers are formed on both sides/a separator like a roll (like a scroll), housing the obtained structure in a metal casing having a closed bottom, connecting the negative electrode to a negative electrode terminal and the positive electrode to a positive electrode terminal followed by impregnation with an electrolyte solution, and then sealing the casing.

For example, in the case of a lithium ion secondary battery, the electrolyte solution used is one obtained by dissolving a lithium salt as an electrolyte in a non-aqueous organic solvent at a concentration of about 1 M.

Examples of the lithium salts for the electrolyte solution include LiClO₄, LiBF₄, LiI, LiPF₆, LiCF₃SO₃, LiCF₃CO₂, LiAsF₆, LiSbF₆, LiAlCl₄, LiCl, LiBr, LiB(C₂H₅)₄, LiCH₃SO₃, LiC₄F₉SO₃, Li(CF₃SO₂)₂N, and Li[(CO₂)₂]₂B.

Examples of the non-aqueous organic solvent include carbonates such as propylene carbonate, ethylene carbonate, butylene carbonate, dimethyl carbonate, diethyl carbonate, and methyl ethyl carbonate; lactones such as γ-butyrolactone; ethers such as trimethoxymethane, 1,2-dimethoxyethane, diethyl ether, 2-ethoxyethane, tetrahydrofuran, and 2-methyltetrahydrofuran; sulfoxides such as dimethyl sulfoxide; oxolanes such as 1,3-dioxolane and 4-methyl-1,3-dioxolane; nitrogen-containing solvents such as acetonitrile, nitromethane, and NMP; esters such as methyl formate, methyl acetate, butyl acetate, methyl propionate, ethyl propionate, and phosphoric acid triesters; glymes such as diglyme, triglyme and tetraglyme; ketones such as acetone, diethyl ketone, methyl ethyl ketone, and methyl isobutyl ketone; sulfones such as sulfolane; oxazolidinones such as 3-methyl-2-oxazolidinone; and sultones such as 1,3-propanesultone, 4-butanesultone, and naphthasultone. One electrolyte solution may be used alone, or two or more electrolyte solutions may be used in combination.

### <Secondary Battery>

A battery can be produced by a known method. For example, in the case of a lithium ion secondary battery, which is a non-aqueous secondary battery, first, two electrodes of a positive electrode and a negative electrode are wound with a separator made of a polyethylene microporous membrane interposed therebetween. The obtained spirally wound group is inserted into a battery can, and a tab terminal which has been welded to a current collector of a negative electrode in advance is welded to the bottom of the battery can. To the obtained battery can, an electrolyte solution is poured. Further, a tab terminal which has been welded to a current collector of a positive electrode in advance is welded to a lid of the battery. The lid is arranged above the battery can with a gasket having insulating properties interposed therebetween. The contact portion between the lid and the battery can is crimped for sealing. Thus, a battery is obtained.

### EXAMPLES

Hereinafter, the present invention will be described in further detail based on Examples; however, the scope of the present invention is not limited to Examples below.

### <Synthesis of Binder Resin for Secondary Battery Electrode>

### Production Example 1

In a 1 liter separable flask equipped with a stirrer, a thermometer, a condenser, and a nitrogen gas inlet tube, 235 g of distilled water and 1% by mass of an aqueous sulfuric acid solution were placed, and bubbled with nitrogen gas supplied at a rate of 100 mL/minute for 15 minutes. The temperature was raised to 60° C. with stirring, and the supply of nitrogen gas was switched to flow supply.

Subsequently, 0.27 g of ammonium persulfate, 0.81 g of 50% by mass ammonium hydrogen sulfite, 0.1875 g of 0.01% by mass iron sulfate, and 15 g of distilled water were added as a polymerization initiator.

A monomer mixture of 24.91 g of acrylonitrile and 0.10 g of LIGHT ESTER P1-M (trade name, manufactured by Kyoeisha Chemical Co., Ltd., 2-methacryloyloxyethyl acid phosphate, hereinafter the same) was bubbled with nitrogen gas for 15 minutes, and then added dropwise to the separable flask over 30 minutes. After completion of the dropwise addition, the temperature was held at 60° C. for 3 hours to complete the polymerization.

After the stirring was stopped, the reaction liquid was cooled and filtered under reduced pressure. After washing with hot water at 60° C., drying was conducted at 80° C. for 24 hours to obtain a polymer (A1).

The mass-average molecular weight of the polymer (A1) measured by GPC was 1,050,000.

### <Method for Measuring Mass-Average Molecular Weight>

The polymer was dissolved in DMF serving as a solvent at a concentration of 500 ppm. The polymer solution in which the polymer was dissolved was subjected to GPC (manufactured by Tosoh Corporation, trade name: HLC-8220GPC, columns: two TOSOH TSK-GEL Super HZM-H columns (6.0 mm in diameter×15 cm), column temperature: 40° C.) to determine the mass-average molecular weight. Polystyrene was used as the standard substance. Hereinafter, the same method was used.

### Production Example 2

A polymer (A2) was obtained in the same manner as in Production Example 1, except that the monomers added dropwise were changed to a mixture of 24.50 g of acrylonitrile and 0.49 g of LIGHT ESTER P1-M.

The mass-average molecular weight of the polymer (A2) measured by GPC was 470,000.

### Production Example 3

A polymer (A3) was obtained in the same manner as in Production Example 1, except that the monomers added dropwise were changed to a mixture of 24.16 g of acrylonitrile and 0.97 g of LIGHT ESTER P1-M.

The mass-average molecular weight of the polymer (A3) measured by GPC was 410,000.

### Production Example 4

In a 1 liter separable flask equipped with a stirrer, a thermometer, a condenser, and a nitrogen gas inlet tube, 235 g of distilled water, 1% by mass of an aqueous sulfuric acid solution, and 0.0125 g of sodium hypophosphite were placed, and bubbled with nitrogen gas supplied at a rate of 100 mL/minute for 15 minutes. The temperature was raised to 60° C. with stirring, and the supply of nitrogen gas was switched to flow supply.

Subsequently, 0.27 g of ammonium persulfate, 0.81 g of 50% by mass ammonium hydrogen sulfite, 0.1875 g of 0.01% by mass iron sulfate, and 15 g of distilled water were added as a polymerization initiator.

A monomer mixture of 24.50 g of acrylonitrile and 0.49 g of LIGHT ESTER P1-M was bubbled with nitrogen gas for 15 minutes, and then added dropwise to the separable flask over 30 minutes. After completion of the dropwise addition, the temperature was held at 60° C. for 3 hours to complete the polymerization.

After the stirring was stopped, the reaction liquid was cooled and filtered under reduced pressure. After washing with hot water at 60° C., drying was conducted at 80° C. for 24 hours to obtain a polymer (A4).

The mass-average molecular weight of the polymer (A4) measured by GPC was 450.000.

### Production Example 5

A polymer (A5) was obtained in the same manner as in Production Example 4, except that the monomers added dropwise were changed to a mixture of 24.16 g of acrylonitrile and 0.97 g of LIGHT ESTER P1-M.

The mass-average molecular weight of the polymer (A5) measured by GPC was 370,000.

### Production Example 6

A polymer (A6) was obtained in the same manner as in Production Example 4, except that the amount of sodium hypophosphite used was changed to 0.25 g.

The mass-average molecular weight of the polymer (A6) measured by GPC was 310,000.

### Production Example 7

A polymer (A7) was obtained in the same manner as in Production Example 4, except that the monomers added dropwise were changed to a mixture of 22.46 g of acrylonitrile and 2.67 g of LIGHT ESTER P1-M.

The mass-average molecular weight of the polymer (A7) measured by GPC was 440,000.

### Production Example 8

A polymer (A8) was obtained in the same manner as in Production Example 4, except that the monomers added dropwise were changed to a mixture of 20.77 g of acrylonitrile and 4.33 g of LIGHT ESTER P1-M.

The mass-average molecular weight of the polymer (A8) measured by GPC was 230,000.

### Production Example 9

A polymer (A9) was obtained in the same manner as in Production Example 4, except that the monomers added dropwise were a mixture of 20.77 g of acrylonitrile and 4.33 g of LIGHT ESTER P1-M, and sodium hypophosphite added was changed to 0.25 g.

The mass-average molecular weight of the polymer (A9) measured by GPC was 80,000.

### Production Example 10

A polymer (B1) was obtained in the same manner as in Production Example 1, except that the monomers added dropwise were changed to a mixture of 24.50 g of acrylonitrile and 0.50 g of methacrylic acid.

The mass-average molecular weight of the polymer (B1) measured by GPC was 430,000.

### Production Example 11

A polymer (B2) was obtained in the same manner as in Production Example 10, except that ammonium persulfate added was changed to 0.05 g, 50% by mass ammonium hydrogen sulfite added was changed to 0.16 g, and 0.01% by mass iron sulfate added was changed to 0.038 g.

The mass-average molecular weight of the polymer (B2) measured by GPC was 770,000.

### Production Example 12

In a 1 liter separable flask equipped with a stirrer, a thermometer, a condenser, and a nitrogen gas inlet tube, 235 g of distilled water and 1% by mass of an aqueous sulfuric acid solution were placed, and bubbled with nitrogen gas supplied at a rate of 100 mL/minute for 15 minutes. The temperature was raised to 60° C. with stirring, and the supply of nitrogen gas was switched to flow supply.

Subsequently, 0.27 g of ammonium persulfate, 0.81 g of 50% by mass ammonium hydrogen sulfite, 0.1875 g of 0.01% by mass iron sulfate, and 15 g of distilled water were added as a polymerization initiator.

A monomer mixture of 25.0 g of acrylonitrile was bubbled with nitrogen gas for 15 minutes, and then added dropwise to the separable flask over 30 minutes. After completion of the dropwise addition, the temperature was held at 60° C. for 3 hours to complete the polymerization.

After the stirring was stopped, the reaction liquid was cooled and filtered under reduced pressure. After washing with hot water at 60° C., drying was conducted at 80° C. for 24 hours to obtain a polymer (C1).

The mass-average molecular weight of the polymer (C1) measured by GPC was 310.000.

Table 1 shows the initial mole ratios for the synthesis of the binder resins of Production Examples 1 to 12 and the mass-average molecular weights of the binder resins. In Table 1, numeric values of the constitutions are expressed in the unit of % by mole.

TABLE 1

| | | | Production Example | | | | | |
|---|---|---|---|---|---|---|---|---|
| | | | 1 | 2 | 3 | 4 | 5 | 6 |
| | Polymer | | (A1) | (A2) | (A3) | (A4) | (A5) | (A6) |
| Constitution | Vinyl cyanide monomer | Acrylonitrile | 99.9 | 99.5 | 99.0 | 99.5 | 99.0 | 99.5 |
| | Acid group-containing | P1-M | 0.1 | 0.5 | 1.0 | 0.5 | 1.0 | 0.5 |
| | monomer | Methacrylic acid | — | — | — | — | — | — |

| | | | | | | | |
|---|---|---|---|---|---|---|---|
| Polymer | Mass-average molecular weight | 1,050,000 | 470,000 | 410,000 | 450,000 | 370,000 | 310,000 |
| evaluation | | | | | | | |

Production Example

| | | | 7 | 8 | 9 | 10 | 11 | 12 |
|---|---|---|---|---|---|---|---|---|
| | Polymer | | (A7) | (A8) | (A9) | (B1) | (B2) | (C1) |
| Constitution | Vinyl cyanide monomer | Acrylonitrile | 97.0 | 95.0 | 95.0 | 98.8 | 98.8 | 100.0 |
| | Acid group-containing | P1-M | 3.0 | 5.0 | 5.0 | — | — | — |
| | monomer | Methacrylic acid | — | — | — | 1.2 | 1.2 | — |

| | | | | | | | |
|---|---|---|---|---|---|---|---|
| Polymer | Mass-average molecular weight | 440,000 | 230,000 | 80,000 | 430,000 | 770,000 | 310,000 |
| evaluation | | | | | | | |

### Example 1

An electrode slurry composition using the polymer (A1) produced in Production Example 1 described above was prepared as described below, and the properties thereof were evaluated.

### <Preparation of Slurry for Battery Electrode>

Lithium cobaltate (manufactured by NIPPON CHEMICAL INDUSTRIAL CO., LTD, trade name: CELLSEED C-5H), acetylene black (manufactured by Denki Kagaku Kogyo Kabushiki Kaisha, trade name: DENKABLACK), and the polymer (A1) as a binder resin for a battery electrode were mixed together at a mass ratio of 100:5:3, and kneaded, while NMP used as a solvent was added to achieve a so-called thick-paste-kneading (KATANERI). For the kneading, a planetary centrifugal mixer (manufactured by THINKY, trade name: AWATORI RENTAROARV-200, hereinafter the same) was used. Further, NMP was added followed by kneading, to lower the solid content to achieve a viscosity usable for application. Thus, a finished slurry for a battery electrode was obtained.

### <Fabrication of Electrode>

The slurry prepared as described above was applied onto a current collector by using a doctor blade. The doctor blade was set to a film thickness of 220 μm, and the current collector used was aluminum foil (thickness: 20 μm). The current collector onto which the slurry was applied was dried at 80° C. for 50 minutes to obtain an electrode having a mass per unit area of 21 mg/cm².

### <Evaluation of Flexibility of Electrode>

From the electrode, a piece of 30 mm in width×50 mm in length was cut out, and pressed with a press roll to adjust the electrode density to 3 g/cm³. Thus, test piece 1 was prepared. Subsequently, mandrels (diameters were 16 mm, 10 mm, 8 mm, 6 mm, and 5 mm) were placed on the aluminum foil of the test piece 1, and one side of the test piece 1 was fixed with tape. The test piece 1 was bent with the aluminum foil surface facing the inside. Here, the state of the mixture layer was visually observed, and the flexibility of the electrode was evaluated by using the following evaluation criteria.
◯: Unchanged.
×: Cracking or peeling occurred.

### (Evaluation of Binding Property)

From the positive electrode, a piece of 20 mm in width and 80 mm in length was cut out, and pressed with a press roll to adjust the electrode density to 3 g/cm³. Then, the mixture layer surface of the cut piece was fixed to a polycarbonate sheet (25 mm in width, 100 mm in length, and 1 mm in thickness) with double-sided tape (manufactured by Sekisui Chemical Co., Ltd., trade name: #570). Thus, test piece 2 was prepared. Test piece 2 was set to a tensile strength test TENSILON tester (manufactured by Orientec Co., Ltd., trade name: RTC-1210A), and the aluminum foil was peeled by 180° at 10 mm/minute to determine the peel strength (Unit: N/cm). The test was repeated five times, and the average value thereof was recorded.

### Examples 2 to 8

Electrodes were fabricated and the flexibility and the binding property thereof were evaluated in the same manner as in Example 1, except that the polymers (A2) to (A8) were used as the binder resin for a battery electrode.

### Example 9

As a binder resin for a battery electrode, a mixture of polymer (A2):polymer (C1):polyglycerin #500 (trade name, manufactured by Sakamoto Yakuhin Kogvo Co., Ltd., polyglycerin average molecular weight: 500) as an additive at a mass ratio of 45:45:10 was used.

Lithium cobaltate (manufactured by NIPPON CHEMICAL INDUSTRIAL CO., LTD, trade name: CELLSEED C-5H), acetylene black (manufactured by Denki Kagaku Kogyo Kabushiki Kaisha, trade name: DENKABLACK), and the binder resin composition after mixing were mixed together at a mass ratio of 100:5:3, and kneaded, while NMP used as a solvent was added to achieve a so-called thick-paste-kneading. For the kneading, a planetary centrifugal mixer was used. Further, NMP was added followed by kneading, to lower the solid content to achieve a viscosity usable for application. Thus, a finished slurry for a battery electrode was obtained.

An electrode was fabricated and the flexibility and the binding property thereof were evaluated in the same manner as in Example 1.

### Example 10

An electrode was fabricated and the flexibility and the binding property thereof were evaluated in the same manner as in Example 9, except that the mixed binder resin composition used contained polymer (A2):polymer (C1):polyglycerin #500 at a mass ratio of 63:27:10.

### Example 11

An electrode was fabricated and the flexibility and the binding property thereof were evaluated in the same manner as in Example 9, except that the mixed binder resin composition used contained polymer (A5):polymer (C1):polyglycerin #500 at a mass ratio of 63:27:10.

### Example 12

An electrode was fabricated and the flexibility and the binding property thereof were evaluated in the same manner as in Example 9, except that the mixed binder resin composition used contained polymer (A5):polymer (C1):polyglycerin #500 at a mass ratio of 56:24:20.

### Example 13

An electrode was fabricated and the flexibility and the binding property thereof were evaluated in the same manner as in Example 9, except that the mixed binder resin composition used contained polymer (A2):polymer (B1) at a mass ratio of 50:50.

### Example 14

An electrode was fabricated and the flexibility and the binding property thereof were evaluated in the same manner as in Example 9, except that the mixed binder resin used contained polymer (A2):polymer (B1) at a mass ratio of 25:75.

### Example 15

An electrode was fabricated and the flexibility and the binding property thereof were evaluated in the same manner as in Example 9, except that a mixed binder resin used contained polymer (A2):polymer (B1) at a mass ratio of 10:90.

### Example 16

An electrode was fabricated and the flexibility and the binding property thereof were evaluated in the same manner as in Example 9, except that the mixed binder resin used contained polymer (A2):polymer (B1):polyglycerin #500 at a mass ratio of 9:81:10.

### Example 17

### <Preparation of Slurry for Battery Electrode>

Lithium titanate (LTO) (manufactured by Sigma-Aldrich Corporation, trade name: Lithium titanate, spinel), acetylene black (manufactured by Denki Kagaku Kogyo Kabushiki Kaisha, trade name: DENKABLACK), and the polymer (A2) and the polymer (B1) as a binder resin were mixed together at a mass ratio of 100:5:1.5:1.5, and kneaded, while NMP used as a solvent was added to achieve a so-called thick-paste-kneading. For the kneading, a planetary centrifugal mixer was used. Further, NMP was added followed by kneading, to lower the solid content to achieve a viscosity usable for application. Thus, a finished slurry for a battery electrode was obtained.

### <Fabrication of Electrode>

The slurry prepared as described above was applied onto a current collector by using a doctor blade. The current collector used was aluminum foil (thickness: 20 μm). The current collector onto which the slurry was applied was dried at 80° C. for 50 minutes to obtain an electrode having a mass per unit area of 11.2 mg/cm².

The flexibility and the binding property of the electrode were evaluated in the same manner as in Example 1, except that the film thickness was adjusted to approximately 70 μm, and the electrode density was adjusted to 1.6 g/cm³ by pressing with a press roll.

### Example 18

An electrode was fabricated and the flexibility and the binding property thereof were evaluated in the same manner as in Example 17, except that the mixed binder resin used contained polymer (A2):polymer (B1) at a mass ratio of 25:75.

### Example 19

An electrode was fabricated and the flexibility and the binding property thereof were evaluated in the same manner as in Example 17, except that the mixed binder resin used contained polymer (A2):polymer (B1) at a mass ratio of 10:90.

### Comparative Examples 1 and 2

Electrodes were fabricated and the flexibility and the binding property thereof were evaluated in the same manner as in Example 1, except that the polymers (A9) and (B2) were used as the binder resin for a battery electrode, respectively.

Table 2 shows the evaluation results of Examples 1 to 19 and Comparative Examples 1 and 2. The numeric values of the binder resins in Table 2 represent the mass ratios.

TABLE 2

| | | | Example | | | | | | |
|---|---|---|---|---|---|---|---|---|---|
| | | | 1 | 2 | 3 | 4 | 5 | 6 | 7 |
| Binder | (A1) | | 100 | — | — | — | — | — | — |
| resin | (A2) | | — | 100 | — | — | — | — | — |
| | (A3) | | — | — | 100 | — | — | — | — |
| | (A4) | | — | — | — | 100 | — | — | — |
| | (A5) | | — | — | — | — | 100 | — | — |
| | (A6) | | — | — | — | — | — | 100 | — |
| | (A7) | | — | — | — | — | — | — | 100 |
| | (A8) | | — | — | — | — | — | — | — |
| Evaluation | Flexibility | 16 | ∘ | ∘ | ∘ | ∘ | ∘ | ∘ | ∘ |
| results | [mm] | 10 | ∘ | ∘ | ∘ | ∘ | ∘ | ∘ | ∘ |
| | | 8 | ∘ | ∘ | ∘ | ∘ | ∘ | ∘ | ∘ |
| | | 6 | x | ∘ | ∘ | ∘ | ∘ | x | x |
| | | 5 | x | ∘ | ∘ | x | ∘ | x | x |

| | | | | | | | |
|---|---|---|---|---|---|---|---|
| Binding property [N/cm] | 1.81 | 2.12 | 1.92 | 2.12 | 1.86 | 1.99 | 1.80 |

| | | | Example | | | | | | | |
|---|---|---|---|---|---|---|---|---|---|---|
| | | | 9 | 10 | 11 | 12 | 13 | 14 | 15 | 16 |
| | (A2) | | 45 | 63 | — | — | 50 | 25 | 10 | 9 |
| | (A5) | | — | — | 63 | 56 | — | — | — | — |
| | (B1) | | — | — | — | — | 50 | 75 | 90 | 81 |
| | (C1) | | 45 | 27 | 27 | 24 | — | — | — | — |
| Additive | Polyglycerin | | 10 | 10 | 10 | 20 | — | — | — | 10 |
| Evaluation | Flexibility | 16 | ∘ | ∘ | ∘ | ∘ | ∘ | ∘ | ∘ | ∘ |
| results | [mm] | 10 | ∘ | ∘ | ∘ | ∘ | ∘ | ∘ | ∘ | ∘ |
| | | 8 | ∘ | ∘ | ∘ | ∘ | ∘ | ∘ | ∘ | x |
| | | 6 | x | ∘ | ∘ | ∘ | x | x | x | x |
| | | 5 | x | x | x | ∘ | x | x | x | x |

| | | | | | | | | |
|---|---|---|---|---|---|---|---|---|
| Binding property [N/cm] | 0.61 | 1.16 | 1.26 | 1.02 | 2.04 | 1.91 | 1.95 | 1.92 |

| | | | Example 17 | Example 18 | Example 19 | Comp. Ex. 1 | Comp. Ex. 2 |
|---|---|---|---|---|---|---|---|
| | (A2) | | 50 | 25 | 10 | — | — |
| | (A9) | | — | — | — | 100 | — |
| | (B1) | | 50 | 75 | 90 | — | — |
| | (B2) | | — | — | — | — | 100 |
| Evaluation | Flexibility | 16 | ∘ | ∘ | ∘ | x | ∘ |
| results | [mm] | 10 | ∘ | ∘ | ∘ | x | x |
| | | 8 | ∘ | ∘ | ∘ | x | x |
| | | 6 | ∘ | x | x | x | x |
| | | 5 | x | x | x | x | x |

| | | | | | |
|---|---|---|---|---|---|
| Binding property [N/cm] | 0.86 | 0.85 | 0.83 | 0.4 | 0.9 |

### Example 20

Slurry compositions for electrodes using the polymers produced in Production Example described above as the binder resins were prepared as described below, and the gel formation of the slurry compositions was evaluated.

### <Preparation of Slurry for Battery Electrode>

A ternary active material NMC111 (manufactured by NIPPON CHEMICAL INDUSTRIAL CO., LTD, trade name: CELLSEED NMC-11) and the polymer (A2) as a binder resin for a battery electrode were mixed together at a mass ratio of 100:3, and kneaded, while NMP used as a solvent was added to achieve a so-called thick-paste-kneading. For the kneading, a planetary centrifugal mixer was used. Further, NMP was added followed by kneading to adjust the solid content to 55%. Thus, a finished slurry for a battery electrode was obtained. The viscosity of the slurry immediately after the fabrication was visually observed.

In addition, 24 hours later, the slurry was kneaded with the above-described mixer for 2 minutes, and then allowed to stand for 1 minute. Then, the viscosity of the slurry was visually observed.

### Example 21

A slurry was evaluated for the gel formation in the same manner as in Example 20, except that the binder resin used was changed to polymer (A3):polymer (B1) at a mass ratio of 50:50.

### Example 22

A slurry was evaluated for the gel formation in the same manner as in Example 20, except that the binder resin used was changed to polymer (A3):polymer (C1) at a mass ratio of 50:50.

### Example 23

Lithium titanate (LTO) and the polymer (A2) as a binder resin for a battery electrode were mixed together at a mass ratio of 100:3, and kneaded, while NMP used as a solvent was added to achieve a so-called thick-paste-kneading. For the kneading, a planetary centrifugal mixer was used. Further, NMP was added followed by kneading to adjust the solid content to 50%. Thus, a finished slurry for a battery electrode was obtained. The viscosity of the slurry immediately after the fabrication was visually checked.

In addition, 24 hours later, the slurry was kneaded with the above-described mixer for 2 minutes, and then allowed to stand for 1 minute. Then, the viscosity of the slurry was visually checked.

### Example 24

A slurry was evaluated for the gel formation in the same manner as in Example 23, except that the binder resin used was changed to polymer (A3):polymer (B1) at a mass ratio of 50:50.

### Example 25

A slurry was evaluated for the gel formation in the same manner as in Example 23, except that the binder resin used was changed to polymer (A3):polymer (C1) at a mass ratio of 50:50.

### Example 26

A slurry was evaluated for the gel formation in the same manner as in Example 20, except that the binder resin used was changed to polymer (A2):polymer (B1) at a mass ratio of 10:90.

### Example 27

A slurry was evaluated for the gel formation in the same manner as in Example 20, except that the binder resin used was changed to polymer (A2):polymer (B1) at a mass ratio of 5:95.

### Example 28

A slurry was evaluated for the gel formation in the same manner as in Example 23, except that the binder resin used was changed to polymer (A2):polymer (B1) at a mass ratio of 10:90.

### Example 29

A slurry was evaluated for the gel formation in the same manner as in Example 23, except that the binder resin used was changed to polymer (A2):polymer (B1) at a mass ratio of 5:95.

Table 3 shows the results of Examples 20 to 29. Note that the numeric values in the table are expressed in the unit of parts by mass. The results of the visual evaluation were reported as follows.

a: No rise in viscosity of the slurry was noticeable by the visual observation.

b: A rise in viscosity of the slurry was noticed by the visual observation, but the slurry was flowable.

c: A rise in viscosity of the slurry was noticed by the visual observation, and the slurry was in a state where it was almost non-flowable even when the container was tilted, without applying any force.

d: The slurry was in a so-called gelled state where the slurry was completely non-flowable even when a fore was applied.

TABLE 3

| | | Example | | | | | |
|---|---|---|---|---|---|---|---|
| | | 20 | 21 | 22 | 23 | 24 | 25 |
| Active material | NMC111 | 100 | 100 | 100 | — | — | — |
| | LTO | — | — | — | 100 | 100 | 100 |
| Binder resin | (A2) | 3 | — | — | 3 | — | — |
| | (A3) | — | 1.5 | 1.5 | — | 1.5 | 1.5 |
| | (B1) | — | 1.5 | — | — | 1.5 | — |
| | (C1) | — | — | 1.5 | — | — | 1.5 |
| Evaluation results | Immediately after fabrication | b | a | a | d | c | c |
| | 24 hours later | d | c | c | d | c | c |

Example

| | | 26 | 27 | 28 | 29 |
|---|---|---|---|---|---|
| Active material | NMC111 | 100 | 100 | — | — |
| | LTO | — | — | 100 | 100 |
| Binder resin | (A2) | 0.3 | 0.15 | 0.3 | 0.15 |
| | (B1) | 2.7 | 2.85 | 2.7 | 2.85 |
| Evaluation results | Immediately after fabrication | a | a | a | a |
| | 24 hours later | a | a | b | a |

Each of the electrodes (Examples 1 to 19) produced by using the binder resins of the present invention had a high flexibility and the binding property of the binder resin was also high.

Examples 13 to 16 show the binder resins in which the phosphoric acid group-containing polymer (A) and the carboxyl group-containing polymer (B) were mixed. When a comparison is made among the cases of the same active material, the binder resins were especially excellent in balance between the flexibility and the binding property.

The binder resin described in Comparative Example 1 had a molecular weight of 80.000, which was lower than 200,000. Hence, the binder resin excessively dissolved in NMP, which was the solvent, during the preparation of the slurry, and the binder resin covered the active material in the slurry, which resulted in impairment of the flexibility of the mixture layer after the fabrication of the electrode.

The binder resin described in Comparative Example 2 did not contain the phosphoric acid group-containing polymer (A). Hence, the fabricated electrode was not able to express sufficient binding property or sufficient flexibility.

Depending on the active material used, thickening or gel formation was observed in the slurry compositions of the present invention. However, when the carboxyl group-containing polymer (B) or the acidic group-free polymer (C) is used in combination, an electrode having a high binding property and a high flexibility can be fabricated, while suppressing the gel formation.

The effects of the use in combination are apparent from Examples 20 to 22 or from Examples 23 to 25.

In Examples 20 to 25, the amounts of the phosphoric acid groups were 0.5% by mole relative to the entire amount of the binder resins. The progression of the gel formation was more suppressed in Examples 21, 22, 24, and 25 in which the polymer (B) and the polymer (C) were used in combination than in Examples 20 and 23 in which the polymer (A) was used alone.

In addition, Examples 26 to 29 have shown that decreasing the amount of the phosphoric acid group-containing polymer (A) can further suppress the gel formation.

1. A binder resin for a secondary battery electrode, comprising
a polymer (A) which contains, as polymer-constituent monomer units, a vinyl cyanide monomer unit at a ratio of 50 to 99.99% by mole and a phosphoric acid group-containing monomer unit at a ratio of 0.01 to 50% by mole, and which has a mass-average molecular weight of 200,000 to 3,000,000.

2. The binder resin for a secondary battery electrode according to claim 1, further comprising
a polymer (B) which contains, as polymer-constituent monomer units, a vinyl cyanide monomer unit at a ratio of 50 to 99.99% by mole and a carboxyl group-containing monomer unit at a ratio of 0.01 to 50% by mole.

3. The binder resin for a secondary battery electrode according to claim 1, wherein
the mass-average molecular weight of the polymer (A) is 200,000 to 2,000,000.

4. The binder resin for a secondary battery electrode according to claim 2, wherein
the mass-average molecular weight of the polymer (B) is 200,000 to 2,000,000.

5. The binder resin for a secondary battery electrode according to claim 2, wherein
the polymer (A) is contained at a ratio of 0.1 to 99% by mass, and the polymer (B) is contained at a ratio of 1 to 99.9% by mass, provided that the total of (A) and (B) is 100% by mass.

6. The binder resin for a secondary battery electrode according to claim 1, further comprising
a polymer (C) which contains a vinyl cyanide monomer unit as a polymer-constituent monomer unit, and which does not contain an acidic group-containing monomer unit.

7. The binder resin for a secondary battery electrode according to claim 2, further comprising
a polymer (C) which contains a vinyl cyanide monomer unit as a polymer-constituent monomer unit, and which does not contain an acidic group-containing monomer unit.

8. The binder resin for a secondary battery electrode according to claim 6, wherein
the polymer (C) has a mass-average molecular weight of 1,000 to 2,000,000.

9. The binder resin for a secondary battery electrode according to claim 6, wherein
the polymer (A) is contained at a ratio of 10 to 99% by mass, and the polymer (C) is contained at a ratio of 1 to 90% by mass, provided that the total of (A) and (C) is 100% by mass.

10. The binder resin for a secondary battery electrode according to claim 7, wherein
the polymer (A) is contained at a ratio of 0.1 to 99% by mass, the polymer (B) is contained at a ratio of 0.9 to 99.8% by mass, and the polymer (C) is contained at a ratio of 0.1 to 94.1% by mass, provided that the total of (A), (B), and (C) is 100% by mass.

11. (canceled)

12. An electrode slurry, comprising:
the binder resin for a secondary battery electrode according claim 1;
an active material; and
a solvent.

13. An electrode for a secondary battery, comprising:
a current collector; and
a mixture layer provided on the current collector, wherein
the mixture layer comprises the binder resin for a secondary battery electrode according to claim 1.

14. A non-aqueous secondary battery, comprising
the electrode for a secondary battery according to claim 13.
